(19) United States
(12) Patent Application Publication
(10) Pub. No.: US 2023/0036257 A1
(43) Pub. Date: Feb. 2, 2023

(54) EFFICIENT RAMAN VISIBLE LASER WITH ENHANCEMENT OF THE CAVITY REFLECTIVITY

(71) Applicant: National Yang Ming Chiao Tung University, Hsinchu City (TW)

(72) Inventors: Yung-Fu Chen, Hsinchu City (TW); Hsing-Chih Liang, Hsinchu City (TW); Chia-Han Tsou, Hsinchu City (TW)

(73) Assignee: National Yang Ming Chiao Tung University, Hsinchu City (TW)

(21) Appl. No.: 17/504,892

(22) Filed: Oct. 19, 2021

(30) Foreign Application Priority Data
Jul. 29, 2021 (TW) 110127969

(51) Int. Cl. H01S 3/109; H01S 3/0941; H01S 3/16; H01S 3/06

(52) U.S. Cl. CPC H01S 3/109; H01S 3/09415; H01S 3/1611; H01S 3/0602

(57) ABSTRACT

The invention discloses a Raman laser apparatus including a linear cavity having a first direction and a second direction opposite to the first direction, the linear cavity including along the first direction: a first optical component, a gain medium, a Raman medium, a lithium triborate (LBO) crystal and a second optical component. The first optical component receives an incident pumping light in the first direction. The gain medium receives the pumping light from the first optical component, and generates a first infrared base laser having a first wavelength. The Raman medium receives the first infrared base laser, and generates a second infrared base laser having a second wavelength. The LBO crystal receives the first and the second infrared base lasers, and generates a visible laser light having a third wavelength. The second optical component is configured to allow the visible laser light to be transmitted out along the first direction.

### CROSS-REFERENCE TO RELATED APPLICATION AND CLAIM OF PRIORITY

This application claims the benefit of Taiwan Patent Application No. 110127969, filed on Jul. 29, 2021, at the Taiwan Intellectual Property Office, the disclosures of which are incorporated herein in their entirety by reference.

### FIELD OF THE INVENTION

The present invention is related to a visible laser device, in particular a visible laser apparatus having a linear cavity with enhancement of the cavity reflectivity.

### BACKGROUND OF THE INVENTION

Laser lights with visible light wavelengths (approximately 390-700 manometers) have high practical value, and are also emerging in industrial processing and even medical technology applications.

FIG. 1 shows a conventional laser device 10 for generating laser light with wavelengths in the range of visible lights, in which the pumping light Lₚᵤₘₚ having a wavelength of 808 nanometer (nm) is supplied from the diode laser source 1 at the leftmost in the figure. A linear laser cavity is formed between the first lens 3 and the second lens 5. Along the first direction, the cavity is furnished with a gain medium 7, a Raman medium 8 and a lithium triborate (LBO) crystal 9.

The gain medium 7 receives the pumping light Lₚᵤₘₚ, and generates a first infrared base laser light L_{base1} having the wavelength of about 1106 nm through energy level conversion. The Raman medium 8 absorbs the first infrared basic laser light. L_{base1}, and generates a second infrared basic laser light L_{base2} with a wavelength of about 1176 nm. Since the surfaces 31/51 of the first lens 3 and the second lens 5 facing the cavity are highly reflective to the first infrared basic laser light L_{base1}, the first infrared basic laser light L_{base1} is reflected back and forth in the linear cavity formed by the first lens 3 and the second lens 5.

With the continuous light energy provided by the pumping light Lₚᵤₘₚ, the gain medium 7 can continuously generate the first infrared base laser light L_{base1} travelling back and forth in the linear cavity, thus continuously exciting the Raman medium 8 to produce the second infrared basic laser light L_{base2} with the wavelength of 1176 nm. The surface 71 of the gain medium 7 is highly reflective to the second infrared basic laser light L_{base2}, so that the second infrared basic laser light L_{base2} is reflected back and forth between the surface 71 of the gain medium 7 and the second lens 5 to form another resonant cavity.

Having received the second infrared basic laser light L_{base2} with a wavelength of about 1176 nm, the LBO crystal 9 can form a visible laser light L1 with a wavelength of about 588 nanometer via second harmonic generating (SHG) process. The visible laser light L1 can also travel back and forth in the linear cavity. The second lens 5 has excellent transparency to the visible laser light: L1, and can allow part of the visible laser light L1 to pass through and exit. The wavelength of 588 nm falls in the region of commonly used visible light, so it has high application value.

However, there is an issue of insufficient output light power in the mentioned device allocation, which needs to rely on high-powered incident pumping light so as to achieve required output powers. Therefore, how to avoid the shortcomings of the above-mentioned devices is a technical problem that needs to be solved.

### SUMMARY OF THE INVENTION

To overcome problems in the prior art, the present invention provides a visible light Raman laser apparatus with enhanced cavity reflectivity, which may escalate the output power of the visible laser light and significantly reduce the issue relevant to power consumption and cost.

According to one aspect of the present invention, a high-power visible light Raman laser apparatus including a linear cavity having a first direction and a second direction opposite to the first direction is disclosed. The linear cavity includes along the first direction: a first optical component, a gain medium, a Raman medium, a lithium triborate (LBO) crystal and a second optical component. The first optical component receives an incident pumping light in the first direction. The gain medium receives the pumping light from the first optical component, and generates a first infrared base laser having a first wavelength. The Raman medium receives the first infrared base laser, and generates a second infrared base laser having a second wavelength. The LBO crystal receives the first and the second infrared base lasers, and generates a visible laser light having a third wavelength. The second optical component is configured to allow the visible laser light to be transmitted out along the first direction, wherein the first optical component has a first high reflectivity for a first wave band including the first wavelength and a second wave band including the second wavelength in the second direction, and the second optical component includes a first surface facing the second direction and a second surface facing the first direction. The first surface has a first high transparency for a third waveband including the third wavelength and a second high reflectivity for the first and the second wavebands in the first direction, and the second surface has a second high transparency for the third waveband and a third high reflectivity for the first and the second wavebands in the first direction.

According to another aspect of the present invention, a linear cavity for generating a high power visible laser light is provided. The linear cavity comprises along a first direction: a gain medium, a Raman medium, a lithium triborate (LBO) crystal and an output coupler. The gain medium receives a pumping light incident in the first direction, and generates a first infrared base laser having a first wavelength. The Raman medium receives the first infrared base laser, and generates a second infrared base laser having a second wavelength. The LBO crystal receives the first and the second infrared base lasers, and generates a visible laser light having a third wavelength. The output coupler is configured to allow the visible laser light to be transmitted out along the first direction. The gain medium includes a first surface facing the second direction, and the first surface has a first high reflectivity for a first waveband including the first wavelength. The gain medium includes a second surface facing the first direction, and the second surface has a second high reflectivity for a second waveband including the second wavelength and a first high transparency for the first waveband. The output coupler includes a third surface facing the second direction and a fourth surface facing the first direction, the third surface has a second high transparency for a third waveband including the third wavelength and a third high reflectivity for the first and the second wavebands in the first direction.

Being different from the traditional Raman output coupling mirror, the double-coated output coupling mirror proposed in the present invention can almost completely lock the fundamental frequency light (such as the basic laser light with a wavelength of about 1064 nm) and the Stokes wave (for example, the basic laser light with a wavelength of about 1158-1159 nm) that is leaked by the traditional Raman laser, so that all the fundamental frequency lights and Stokes waves can be converted into visible light (for example, the basic laser light with a wavelength of about 579 nm), and thereby increase the required visible output light of the Raman laser.

The linear cavity can be employed to provide visible lasers with high out powers, which is useful for medical treatment and industrial needs. Therefore, the present invention has industrial utility.

### BRIEF DESCRIPTION OF THE DRAWINGS

The objectives and advantages of the present invention will become more readily apparent to those ordinarily skilled in the art after reviewing the following detailed descriptions and accompanying drawings.

FIG. 1 is a schematic diagram showing a laser device for generating laser light of visible wavelengths known to the art;

FIG. 2 is a schematic diagram showing a Raman laser with enhancement of cavity reflectivity according to one embodiment of the present invention;

FIG. 3 is a schematic diagram showing a Raman laser with enhancement of cavity reflectivity according to another embodiment of the present invention;

FIG. 4A is a schematic diagram showing the transparency of a conventional output mirror and that of an output mirror in an embodiment of the present invention for light of different wavelengths;

FIG. 4B is a schematic diagram showing the transparency of a conventional output minor and that of an output mirror in another embodiment of the present invention for light of different wavelengths;

FIG. 5A is a schematic diagram showing the relation of the power between the pumping light and the output laser light with wavelength of 579 nanometers generated by the Raman laser according to the prior art;

FIG. 5B is a schematic diagram showing the relation of the power between the pumping light and the output laser light with wavelength of 588 nanometers generated by the Raman laser according to the prior art;

FIG. 6A is a schematic diagram showing the relation of the power between the pumping light and the output laser light with wavelength of 579 nanometers generated by the Raman laser according to one embodiment of the present invention;

FIG. 6B is a schematic diagram showing the relation of the power between the pumping light and the output laser light with wavelength of 588 nanometers generated by the Raman laser according to another embodiment of the present invention.

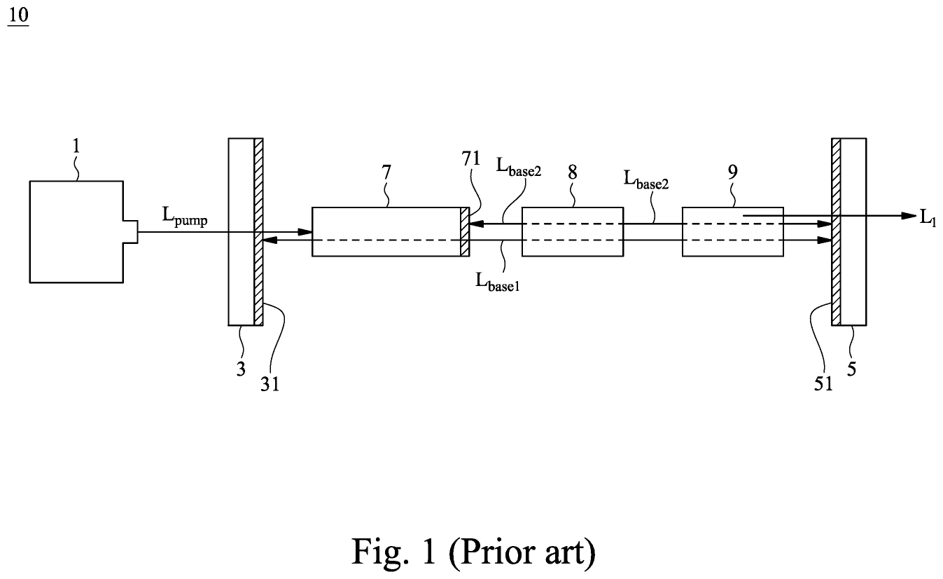

### DETAILED DESCRIPTION OF THE PREFERRED EMBODIMENTS

The present invention will now be described more specifically with reference to the following embodiments. It is to be noted that the following descriptions of the preferred embodiments of this invention are presented herein for the purpose of illustration and description only; they are not intended to be exhaustive or to be limited to the precise form disclosed.

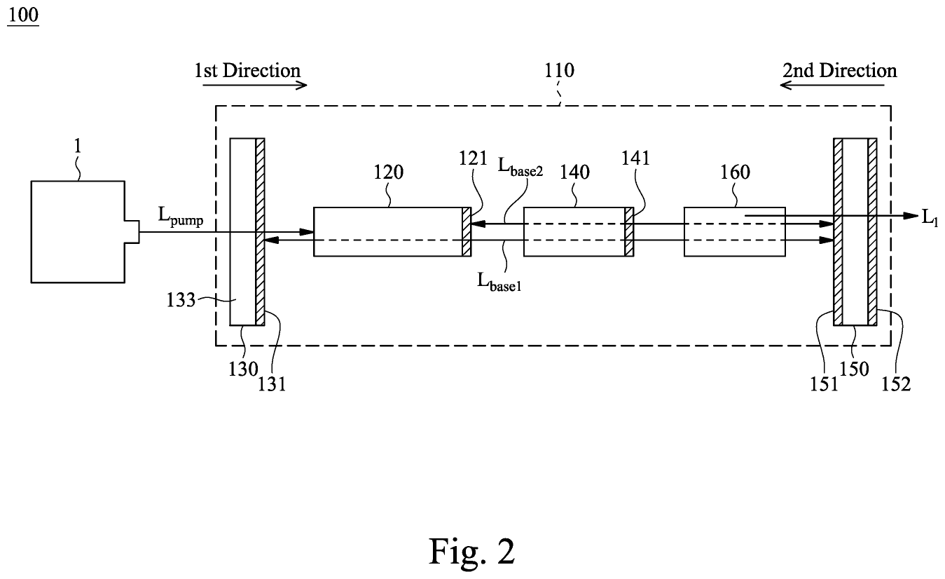

Please refer to FIG. 2, which illustrates a hi-power visible light Raman laser apparatus with a linear cavity according to one embodiment of the present invention. The present invention utilizes the gain medium to generate the first type of infrared base laser light, and makes use of the Raman effect to produce the second type of infrared base laser with different wavelength. The two infrared base laser lights traveling back and forth in the linear cavity can produce visible laser lights of a variety of wavelengths. The hi-power visible Raman laser 100 as illustrated in FIG. 2 includes a linear cavity 110 having a first direction and a second direction opposite to the first direction, and the linear cavity 110 includes the following elements along the first direction: the first optical component 130, the gain medium 120, the Raman medium 140, the triborate (LBO) crystal 160 and the second optical component 150.

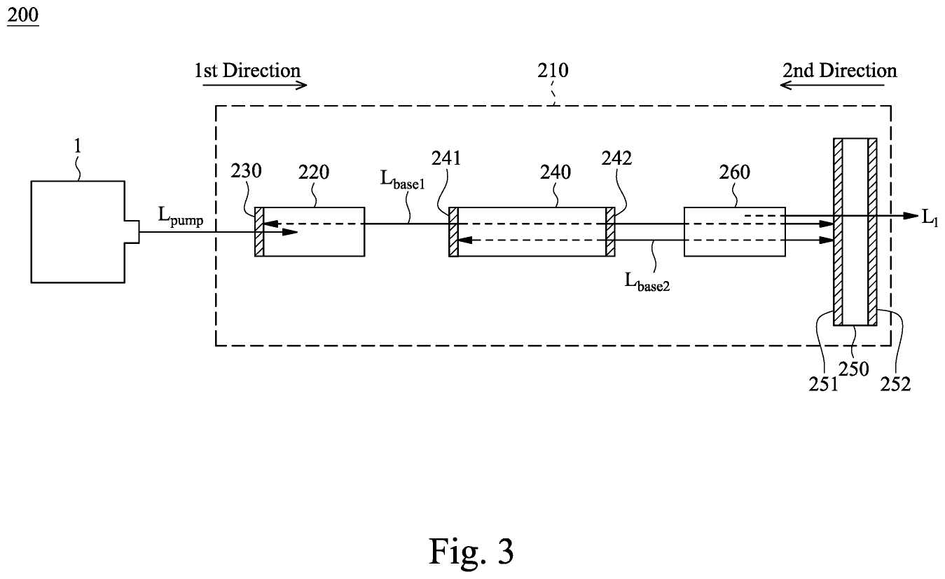

The diode laser source 1 on the far left in FIG. 2 provides a pumping light Lₚᵤₘₚ with a wavelength of about 808 nm, which enters the linear cavity 110 through the first optical element 130 along the first direction. The first optical element 130 is usually a lens with a reflectivity less than 0.2% that allows the incident pumping light Lₚᵤₘₚ to easily penetrate therethrough, and has a surface 131 facing the second direction and a lens body 133 providing the penetration function for the pumping light Lₚᵤₘₚ. Therefore, according to the embodiment shown in FIG. 3, the optical film 130 can be arranged on the incident surface of the gain medium 120 facing the pumping light Lₚᵤₘₚ to realize the corresponding device function equivalent to that of the first optical element 130 in FIG. 2.

According to one embodiment, the gain medium 120 contains neodymium-doped vanadate (such as neodymium-doped yttrium vanadate Nd:YVO4) which can absorb the energy of the pumping light Lₚᵤₘₚ and convert it into the first infrared basic laser light L_{base1} with a wavelength of about 1064 nm, and can transmit the first infrared basic laser light L_{base1} out. The Raman medium 140 comprises a potassium gadolinium tungstate (KGW) crystal, which receives the first infrared basic laser light L_{base1} from the gain medium 120, generates the second infrared base laser L_{base2} with a second wavelength, and transmits the second infrared base laser L_{base2} out.

The reflectivity of the surface 131 of the first optical element 130 facing the second direction and that of the second optical element 150 to the first infrared basic laser light L_{base1} both achieve 99.8% or above, so that the first infrared basic laser light L_{base1} can be effectively locked in the linear cavity 110 to form a standing wave. Likewise, the reflectivity of the surface 121 of the gain medium 120 facing the second direction and that of the second optical element 150 to the second infrared basic laser light L_{base2} both achieve 99.8% or above, so that the second infrared basic laser light: L_{base2} can be effectively locked in the linear cavity 110 to form a standing wave. The two basic laser lights existing in the linear cavity 110 can be used as tools for forming visible laser lights with different wavelengths.

From another perspective, the first infrared basic laser light L_{base1} and the second infrared basic laser light L_{base2} are reflected back and forth in the linear cavity 110, within the first optical element 130, the gain medium 120, and the second optical element 150. It is the distance that makes the two basic laser beams to form standing waves and maintain a certain power. Therefore, the second optical element 150 plays an important role in the linear cavity 110, according to the present invention.

The LBO crystal 160 receives the first or second infrared basic laser light L_{base1}, L_{base2}, and can generate the visible laser light L1 with a third wavelength, According to one embodiment, since the first infrared base laser light L_{base1} emitted from the gain medium 120 has polarity, that is, it is directional for the Raman medium 140 disposed following the optical path shown in FIG. 2. When the Raman medium 140 is realized by a KGW crystal with the Ng axis of the Np-cut section facing upward in the illustration, the first infrared base laser light L_{base1} with a wavelength of about 1064 nm will be absorbed to produce a second infrared basic laser light L_{base2} of about 1158 nm wavelength. When the LBO crystal 160 is realized under appropriate cutting angle, it can be configured to perform the effect: of second harmonic by absorbing the incident the second infrared basic laser light L_{base2} with wavelength of about 1158 nm, and generates the visible laser light L1 with a wavelength of about 579 nm. In this embodiment, the gain medium 120 and the Raman medium 140 in the linear cavity 110 can be maintained at a normal temperature condition such as 20 degrees Celsius at the same time, while the LBO crystal 160 is maintained at about 37 degrees Celsius, which can maintain their optical stability so that the visible laser light L1 generated by the linear cavity 110 has a good power performance.

In order to allow the first infrared basic laser light L_{base1} to be effectively locked in the linear cavity 110 to form a standing wave, time reflectivity of the surface 131 of the first optical element 130 facing the second direction can be configured to be above 99.8% for time lights with wavelength ranged between 1160-1180 nanometers. Likewise, in order to allow the second infrared basic laser light L_{base2} to be effectively locked in the linear cavity 110 to form a standing wave, the reflectivity of the surface 121 of the gain medium 120 facing the second direction can be configured to be above 99.8% for infrared light with wavelength in the range of 1150-1180 nanometers.

In order to simultaneously allow the first infrared basic laser light L_{base1} and the second infrared basic laser light L_{base2} to be effectively locked in the linear cavity 110 to form standing waves, the first surface 151 of the second optical element 150 facing the second direction and the second surface 152 facing the first direction can be configured to have reflectivity of more than 99.8% for infrared light with a wavelength in time range of 920-1160 nanometers, and has a fairly high reflectivity for infrared light with a wavelength in the range of 1160-1176 nanometers. Both the first surface 151 and the second surface 152 of the second optical element 150 have a transparency of more than 95% for visible light with a wavelength in the range of 550-600 nm, which facilitates the outputting of the visible laser light L1 in the first direction. In the above embodiments, the present invention uses coating or pasting to increase the reflectivity or transparency of the surface on the optical elements to lights of certain wavelength.

According to an embodiment, the surface 141 of the Raman medium 140 facing the second direction may be configured to have high reflectivity (for example, 98% or even higher) for visible light waves and high transparency (for example, 99% or even higher) for laser light with wavelengths in the infrared band, so that the visible light laser L1 generated by the linear cavity 110 will not enter the Raman medium 140 and cause any interference.

According to another embodiment, under the same conditions of the first and second infrared basic laser lights L_{base1}, L_{base2}, when the LBO crystal 160 is manufactured with an appropriate cutting angle, it can be configured to implement a sum frequency effect by absorbing the incident first and the second infrared basic laser light L_{base1}, L_{base2}, and then generate the visible laser light L1 with a wavelength of about 556 nm.

According to another embodiment, when the Raman medium 140 is realized by a KGW crystal with the Nm axis of the Np-cut section facing upward in the illustration, the first infrared base laser light L_{base1} with a wavelength of about 1064 nm will be absorbed to produce a second infrared basic laser light L_{base2} of about 1176 nm wavelength. When the LBO crystal 160 is realized under appropriate cutting angle, it can be configured to perform the effect of second harmonic by absorbing the incident the second infrared basic laser light L_{base2} with the wavelength of about 1176 nm, and generates the visible laser light L1 with a wavelength of about 588 nm. In addition, the LBO crystal 160 can be manufactured at a different cutting angle so as to perform the effect of sum frequency and generate visible light. L1 with different wavelengths. In this embodiment, the LBO crystal 160 is maintained at about 24 degrees Celsius, which can maintain the optical stability so that the visible laser light L1 generated by the linear cavity 110 has a good power performance.

Please refer to FIG. 3, which shows a Raman laser with enhancement of cavity reflectivity according to another embodiment of the present invention. The hi-power visible Raman laser 200 as illustrated in FIG. 3 includes a linear cavity 210 having a first direction and a second direction opposite to the first direction, and the linear cavity 210 includes the following elements along the first direction: the first optical component 230, the gain medium 220, the Raman medium 240, the triborate (LBO) crystal 260 and the second optical component 250.

The function as well as material of the gain medium 220, the Raman medium 240 and the LBO crystal 260 are the same as those of the gain medium 120, the Raman medium 140 and the LBO crystal 160 in the example as shown in FIG. 2 respectively, so there is no need to repeat. The diode laser source 1 provides the pumping light Lₚᵤₘₚ with a wavelength of usually 808 nanometers, which enters the linear cavity 210 along the first direction. The gain medium 220 can absorb the energy of the pumping light Lₚᵤₘₚ through the dopant material, convert the energy into a first infrared basic laser light L_{base1} with a wavelength of about 1064 nm, and transmit the first infrared basic laser light L_{base1} out. After receiving the first infrared basic laser light L_{base1} from the gain medium 120, the Raman medium 240 can generate a second infrared basic laser light L_{base2} with a second wavelength, and transmit the second basic laser light L_{base2} out. When the LBO crystal 260 is realized at an appropriate cutting angle, it can be configured to perform functions of double harmonic or sum frequency and generate the visible laser light L1.

According to the aforementioned descriptions, the Raman medium 240 can generate the second infrared basic laser light L_{base2} with the second wavelength of 1158 nm when the KGW crystal with the Ng axis of the Np-cut section facing upward, and can alternatively generate the second infrared basic laser light L_{base2} with the second wavelength of 1176 nm when the KGW crystal with the Nm axis of the Np-cut section facing upward.

According to an embodiment, the surface 242 of the Raman medium 240 facing the second direction may be configured to have high reflectivity (for example, 98% or even higher) for visible light waves and high transparency (for example, 99% or even higher) for laser light with wavelengths in the infrared band, so that the visible light laser L1 generated by the linear cavity 210 will not enter the Raman medium 240 and cause any interference.

The difference from the embodiment shown in FIG. 2 is that, in the embodiment shown in FIG. 3, the first optical element 230 in the linear cavity 210 of the Raman laser device 200 is arranged on the surface of the gain medium 220 facing the incident direction of the pumping light Lₚᵤₘₚ. Moreover, the reflectivity of the first optical element 230 to infrared light having wavelength in the range of 1060-1080 nanometers is above 99.8%, and the surface 241 on the Raman medium 240 facing the first direction has a reflectivity above 99.8% for the infrared light having wavelength within the range of 1150-1180 nanometers. Comparing the contents of FIG. 2 and FIG. 3, it can be seen that the second infrared base laser light L_{base2} in the linear cavity 110 in FIG. 2 is reflected back and forth between the surface 121 of the gain medium 120 facing the second direction and the second optical element 150, while the second infrared basic laser light L_{base2} in the linear cavity 210 in FIG. 3 is reflected back and forth between the surface 241 of the Raman medium 240 facing the first direction and the second optical element 250. The skilled person in the art can refer to the configuration of the devices in the two figures and combine them into a similar laser device.

In the above-mentioned embodiments, the second optical element 150, 250 provided by the present invention is usually realized by a lens. For example, both surfaces of a lens made of glass or polymer materials have been surface-treated to perform the required optical effects. The surface treatment can include surface machining or attaching an optical film with special effects on the surface. According to an embodiment, the surface 151, 251 of the second optical element. 150, 250 facing the cavity direction can be configured as a flat or concave surface, and the surface 152, 252 of the second optical element 150, 250 facing the cavity direction is usually a flat surface.

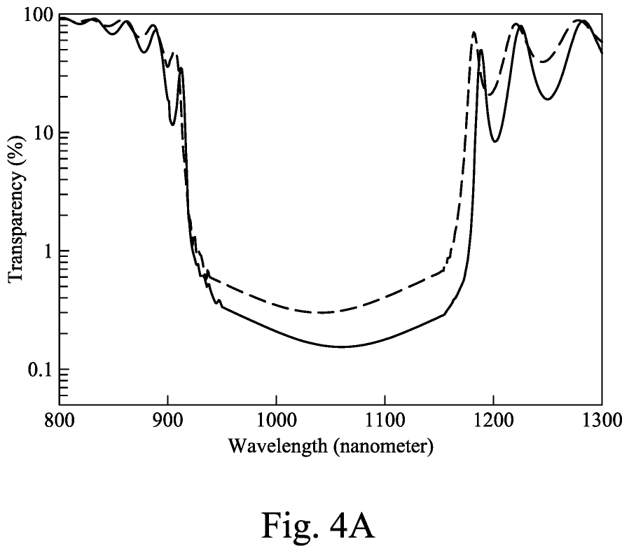

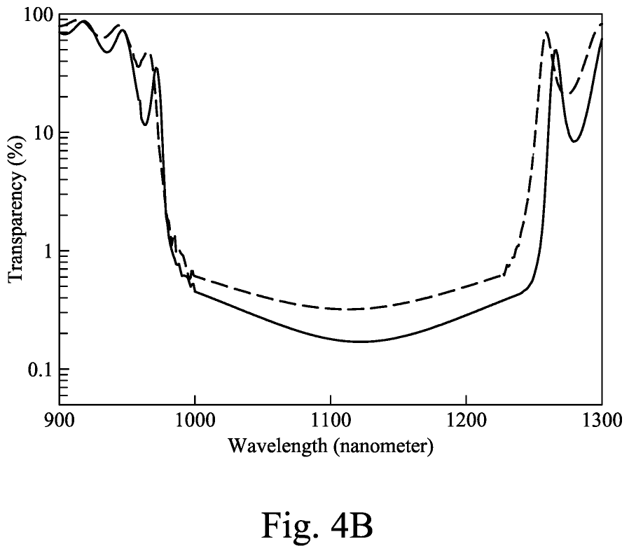

FIG. 4A shows a schematic diagram of the transparencies of a conventional output coupler and those of an output coupler in an embodiment of the present invention for lights with wavelengths in the range of 800-1300 nm. The dotted line in the figure shows the transparencies of the test result under continuous laser light using the traditional output coupler having a coating on the surface facing the cavity only. The solid line shows the test result under continuous laser light using the output coupler with double-sided coating according to the present invention, that is, the second optical element 150, 250 in FIGS. 2 and 3 respectively. The output coupler used in this experiment has a concave surface with a radius of curvature of 70 millimeters on the surface facing the cavity, and the output surface is a flat surface. It should be noted that such an output coupler is used to process the second infrared basic laser light L_{base2} with a wavelength of about 1158 nm.

Comparing the experimental data shown by the dotted and solid lines in FIG. 4A, it can be seen that the traditional output coupler with only one-sided coating has the transparency which is slightly less than 1% (or slightly higher than 99% reflectivity) for the laser lights with wavelength in the range of 920-1160 nm, while the transparency of the double-sided coating output coupler according to the present invention, whose coating conditions or material properties of the two opposite surfaces are the same, has the transparency which is lower than 0.2% (or reflectivity higher than 99.8%) for the laser lights with wavelength in the range of 920-1160 nm. In addition, the high reflectivity of the double-sided coated output coupler according to the present invention can cover a wider range of wavelengths of the laser lights.

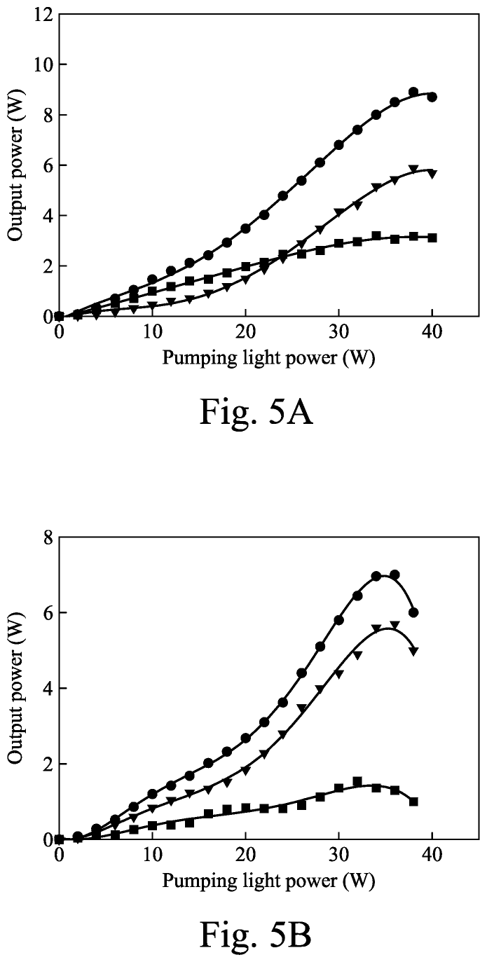

FIG. 5A shows the correlation diagram between the power of the 579 nm output laser light and that of the pumping light generated by using the traditional output coupler, based on the configuration of the Raman laser device shown in FIG. 3. In the figure, the triangle dots show the experimentally measured data of the 579 nm output laser light, the square dots show the data of the 1158 nm basic laser light, and the round dots show the sum of the two laser light powers corresponding to a single pumping light power. The data shown in the figure shows that under the configuration of the 579 nm output laser light generated by the traditional output coupler, there is a serious loss of 1158 nm basic laser light, resulting in insufficient 579 nm output laser light power. For instance, when the pumping light power reaches 30-40 watts (W), the 579 nm output laser light power can hardly reach 4 watts.

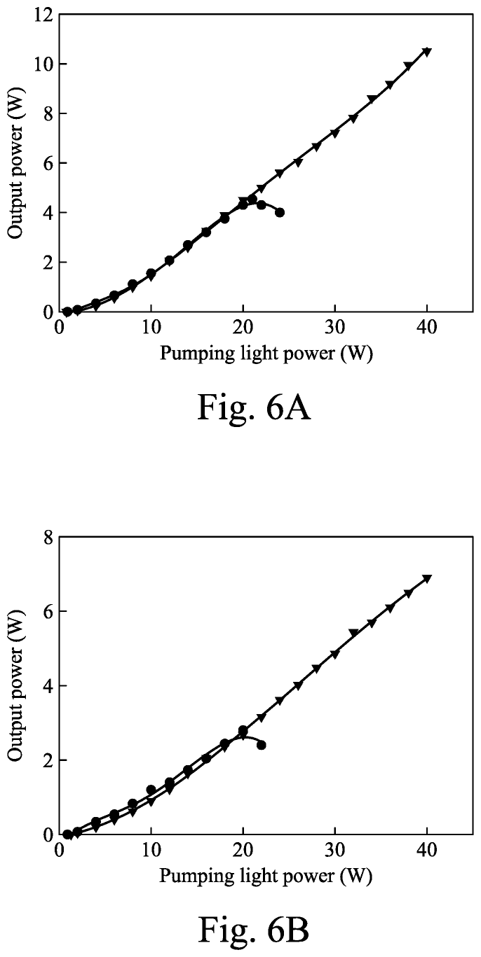

FIG. 6A shows the correlation diagram between the power of the 579 nm output laser light and that of the pumping light generated by using the double-sided coating output coupler of the present invention, based on the configuration of the Raman laser device shown in FIG. 3. The round dots in the figure show the power data of 579 nm output laser light measured with a continuous laser as the pumping light, and the triangle dots show the power data of 579 nm output laser light measured with 50% intermittent laser as the pumping light. When using the double-sided coating output coupler of the present invention as the second optical element, the 1158 nm basic laser light is no longer found in the output light, and the power data of the 579 nm output laser light is very much the same as the sum of the power of the two laser lights in FIG. 5A. When the pumping light power reaches 30-40 watts (W), the power of the 579 nm output laser light reaches 7-10 watts or even more. Comparing the illustrations of FIGS. 5A and 6A, it can be seen that, the output coupler proposed in the present invention with high-reflection optical functions for the infrared based lasers on both sides can effectively suppress the loss of infrared-based lasers. Therefore, the output power of visible laser light is greatly increased.

Please refer to FIG. 4B, which shows a schematic diagram of the transparencies of the conventional output coupler and the output coupler of another embodiment of the present invention for light with a wavelength of 800-1300 nm. In order to fully demonstrate the effectiveness of the visible Raman laser with enhanced reflectivity of the cavity of the present invention, and to verify the above-mentioned perspectives regarding the significant effects of the present invention, a double-sided coating output coupler according to another embodiment of the present invention is provided. The difference between the conventional output coupler and the output coupler of this embodiment of the present invention is at the transparencies of the two, both with a coated concave surface facing the cavity while the latter also has a coated surface at the output surface opposite to the concave surface. The output couplers used in the experiment belong to a configuration that can be used to process the second infrared basic laser light L_{base2} with a wavelength of about 1176 nm.

FIG. 5B shows the correlation diagram between the power of the 588 nm output laser light and the power of the pumping light generated by using the traditional output coupler, based on the configuration of the Raman laser device shown in FIG. 3. In the figure, the triangle dots show the experimentally measured data of the 588 nm output laser light, the square dots show the data of the power of the 1176 nm basic laser light, and the dot shows the sum of the two laser light powers corresponding to a single pumping light power. The data shown in the figure shows that under the configuration of the 588 nm output laser light generated by using the traditional output coupler, there is a loss of 1176 nm basic laser light, resulting in insufficient 588 nm output laser light power. For instance, when the power of the pumping light reaches 30-40 watts (W), the power of the 588 nm output laser light only reaches about 5 watts.

FIG. 6B shows the correlation diagram between the power of the 588 nm output laser light and that of the pumping light generated by using the double-sided coating output coupler of the present invention, based on the configuration of the Raman laser device shown in FIG. 3. The round dots in the figure show the power data of 588 nm output laser light measured with a continuous laser as the pumping light, and the triangle dots show the power data of 588 nm output laser light measured with 50% intermittent laser as the pumping light. When using the double-sided coating output coupler of the present invention as the second optical element, the 1176 nm basic laser light is no longer found in the output light, and the power data of the 588 nm output laser light is very much the same as the sum of the power of the two laser lights in FIG. 5B. When the pumping light power reaches 30-40 watts (W), the power of the 588 nm output laser light reaches 7 watts. Comparing the illustrations of FIGS. 5B and 6B, it can be seen that, the output coupler proposed in the present invention with high-reflection optical functions for the infrared based lasers on both sides can effectively suppress the loss of infrared-based lasers. Therefore, the output power of visible laser light is greatly increased.

Apart from the traditional Raman output coupling mirror, the double-coated output coupler proposed in the present invention can efficiently block the fundamental frequency light (such as the basic laser light with a wavelength of about 1064 nm) and the Stokes waves (for example, the basic laser light with a wavelength of about 1158-1159 nm) that is leaked by the traditional Raman laser, so that all the fundamental frequency lights and Stokes waves can be converted into visible light (for example, the basic laser light with a wavelength of about 579 nanometers), thereby increasing the output of the actually required visible light.

While the invention has been described in terms of what is presently considered to be the most practical and preferred Embodiments, it is to be understood that the invention need not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A high-power visible light Raman laser apparatus including a linear cavity having a first direction and a second direction opposite to the first direction, the linear cavity comprising along the first direction:
a first optical component receiving an incident pumping light in the first direction;
a gain medium receiving the pumping light from the first optical component, and generating a first infrared base laser having a first wavelength;
a Raman medium receiving the first infrared base laser, and generating a second infrared base laser having a second wavelength;
a lithium triborate (LBO) crystal receiving the first and the second infrared base lasers, and generating a visible laser light having a third wavelength; and
a second optical component configured to allow the visible laser light to be transmitted out along the first direction, wherein:
the first optical component has a first high reflectivity for a first wave band including the first wavelength and a second wave band including the second wavelength in the second direction; and
the second optical component includes a first surface facing the second direction and a second surface facing the first direction, the first surface has a first high transparency for a third waveband including the third wavelength and a second high reflectivity for the first and the second wavebands in the first direction, and the second surface has a second high transparency for the third waveband and a third high reflectivity for the first and the second wavebands in the first direction.

2. The Raman laser apparatus according to claim 1, wherein the gain medium includes a neodymium doped vanadate.

3. The Raman laser apparatus according to claim 1, wherein the Raman medium includes a KGW material.

4. The Raman laser apparatus according to claim 1, wherein the first surface is a concave surface, and the second surface is a planar surface.

5. The Raman laser apparatus according to claim 1, wherein the first surface is a planar surface.

6. The Raman laser apparatus according to claim 1, wherein the Raman medium includes a third surface facing the second direction.

7. The Raman laser apparatus according to claim 6, wherein the third surface has a third high transparency for the first waveband and a fourth high reflectivity for the second waveband.

8. The Raman laser apparatus according to claim 6, wherein the Raman medium includes a fourth surface facing the first direction.

9. The Raman laser apparatus according to claim 8, wherein the fourth surface has a fourth transparency for the first and the second wavebands and a fifth high reflectivity for the third waveband.

10. A high-power visible light Raman laser apparatus including a linear cavity having a first direction and a second direction opposite to the first direction, the linear cavity comprising along a first direction:
a gain medium receiving a pumping light incident in the first direction, and generating a first infrared base laser having a first wavelength;
a Raman medium receiving the first infrared base laser, and generating a second infrared base laser having a second wavelength;
a lithium triborate (LBO) crystal receiving the first and the second infrared base lasers, and generating a visible laser light having a third wavelength; and
an output coupler configured to allow the visible laser light to be transmitted out along the first direction, wherein:
the gain medium includes a first surface facing the second direction, and the first surface has a first high reflectivity for a first waveband including the first wavelength;
the gain medium includes a second surface facing the first direction, and the second surface has a second high reflectivity for a second waveband including the second wavelength and a first high transparency for the first waveband; and
the output coupler includes a third surface facing the second direction and a fourth surface facing the first direction, the third surface has a second high transparency for a third waveband including the third wavelength and a third high reflectivity for the first and the second wavebands in the first direction.

11. The Raman laser apparatus according to claim 10, wherein the gain medium includes a neodymium doped vanadate.

12. The Raman laser apparatus according to claim 10, wherein the Raman medium includes a KGW material.

13. The Raman laser apparatus according to claim 10, wherein the third surface is a concave surface, and the fourth surface is a planar surface.

14. The Raman laser apparatus according to claim 10, wherein the third surface is a planar surface.

15. The Raman laser apparatus according to claim 10, wherein the fourth surface has a third high transparency for the third waveband and a fourth high reflectivity for the first and the second wavebands in the first direction.

16. The Raman laser apparatus according to claim 10, wherein the Raman medium includes a fifth surface facing the second direction.

17. The Raman laser apparatus according to claim 16, wherein the fifth surface has a fifth high reflectivity for the third waveband.

18. The Raman laser apparatus according to claim 16, wherein the fifth surface has a fourth high transparency for the first and the second wavebands.
